(19) United States
(12) Patent Application Publication
(10) Pub. No.: US 2009/0039731 A1
(43) Pub. Date: Feb. 12, 2009

(54) Apparatus for Generating Energy and Method Therefor

(76) Inventor: Hyun-Ik Yang, Gyeonggi-do (KR)

Correspondence Address: HOGAN & HARTSON L.L.P., 1999 AVENUE OF THE STARS, SUITE 1400, LOS ANGELES, CA, 90067, US

(21) Appl. No.: 11/722,343

(22) PCT Filed: Dec. 21, 2005
(86) PCT No.: PCT/KR05/04424

§ 371 Date: Mar. 11, 2008

(30) Foreign Application Priority Data
Dec. 21, 2004 (KR) 10-2004-0109440

(51) Int. Cl. G21H 1/00

(52) U.S. Cl. 310/301; 427/457

(57) ABSTRACT

The present invention provides an apparatus for generating energy, which includes: an operating fluid supplied for generating ionization and nuclear fusion reactions; an output pump designed such that the operating fluid is pressurized to a predetermined pressure; an operating fluid supply unit to supply and circulate the operating fluid through the output pump; a dielectric body provided with an inlet and an outlet, to conduct the operating fluid from the operating fluid supply unit, and a plurality of channels with different diameters to connect the inlet and outlet; at least one metallic insert provided with at least one through-hole passing the operating fluid by being inserted into the channels of the dielectric body to ionize the operating fluid; a dielectric insert provided with at least one through-hole passing the operating fluid by being inserted into the channels of the dielectric body to provide an environment promoting nuclear fusion reactions; and at least one pair of metal members to control the polarity of the ionized operating fluid or to collect electricity by being inserted into holes which intercept the channels of the dielectric body in a direction vertical to its axis.

### TECHNICAL FIELD

The present invention relates to an energy generating apparatus and method for converting nuclear fusion energy generated at a normal temperature into thermal or electrical energy. In particular, it consists of an energy generating apparatus and method for developing a physical environment such that the inter-nuclear coulomb barrier can be overcome so as to promote nuclear fusion reactions at a normal temperature without the necessity for strong magnetic fields to confine a high temperature plasma. The apparatus and method permit the ionization of an operating fluid so as to continuously maintain nuclear fusion reactions between atomic nuclei present as positive ions in the fluid. The system can be adapted to obtain thermal or electric energy from the nuclear reaction energy.

### BACKGROUND ART

The usual methods for generating nuclear energy use the nuclei of atoms either by nuclear fusion whereby heavy atomic nuclei are produced by fusing light nuclei, or by nuclear fission in which heavy nuclei are split into lighter nuclei. Nuclear fusion power generation can be conveniently used since it consumes deuterium as a source material which exists plentifully in sea water. It also has a large mass defect in comparison with that in nuclear fission power generation, which uses relatively scarce uranium as a source material.

Herein, nuclear fusion denotes a phenomenon whereby a large amount of energy is emitted by virtue of the mass defect resulting when two light atoms are fused to become one heavy atom. An example of such nuclear fusion is hydrogen fusion.

Although nuclear fusion is more adaptable than nuclear fission for generating energy, there are a number of problems in putting it into practice.

While fusion is possible when deuterium nuclei approach to within 1 fermi from each other, it is very difficult to achieve, since fusion can only be generated in the plasma state and if this high temperature plasma has to be continuously confined, it cools down very rapidly on contacting another material such as the wall of the containing vessel. That is, if energy is to be extracted in the conventional way, the high temperature plasma reaching temperatures ranging from 10⁷˜10⁸ K must be sufficiently confined in a vacuum vessel by a strong magnetic field so as to maintain a high density. The current technology level has not been able to realize this.

As described above, using the nuclear fusion reaction, the source material for nuclear fusion reactions is abundant and nuclear fusion reactions do not cause an environmental pollution or a global warming problem, and the required apparatus is easily implemented, as described below.

### DISCLOSURE

### Technical Problem

The present invention has been developed, in part, to overcome the above-described problems in the related art. It is, therefore, one object of the present invention to provide an energy generating apparatus and method for promoting a physical regime capable of overcoming the coulomb barrier so as to promote nuclear fusion reactions at normal temperatures without the need for strong magnetic fields to confine the high temperature plasma. This is achieved by ionizing an operating fluid so as to continuously maintain nuclear fusion reactions among atomic nuclei present in the fluid as positive ions. The system can be adapted to obtain thermal or electric energy from the reaction energy.

### Technical Solution

In accordance with an aspect of the present invention, there is provided an apparatus for generating energy, including: an operating fluid appropriate for generating ionization and nuclear fusion reactions; an output pump designed such that the operating fluid is supplied at a predetermined pressure; an operating fluid supply unit to provide and circulate the operating fluid by means of an output pump; a dielectric body provided with an inlet and an outlet to conduct the operating fluid provided by the operating fluid supply unit and a plurality of channels with different diameters connecting the inlet and outlet; at least one metallic insert provided with at least one through-hole passing the operating fluid by being inserted into the channels of the dielectric body to ionize the operating fluid; a dielectric insert provided with at least one through-hole passing the operating fluid by being inserted into the channels of the dielectric body to supply an environment promoting nuclear fusion reactions due to cavitation emission; and at least one pair of metal members to control the polarity of the ionized operating fluid or to collect electricity by being inserted into holes which intercept the channels of the dielectric body in a direction vertical to its axis.

The operating fluid in accordance with the present invention is selected from: light water of high purity with resistivity larger than 10⁶ Ω·m; a mixed fluid of high purity with resistivity larger than 10⁶ Ω·m, of which the mixing ratio between light water and heavy water ranges from 100:1 to 100:30; or a mineral oil of viscosity ranging from 5 to 30.

Herein, the apparatus for generating energy further includes: a purifying unit for purifying the light water and the mixed fluid to high purity with resistivity larger than 10⁶ Ω·m to supply the purified light water or mixed fluid to the operating fluid supply unit when the operating fluid is light water or a mixture of light water and heavy water.

The purifying unit in accordance with the present invention includes: a first purifying unit for receiving the light water from an outside source through a light water inlet to initially purify the received light water; a first water storage tank for storing only the light water passing through to the first purifying unit or for mixing pure heavy water supplied through a heavy water inlet with the light water passing through the first purifying unit in a predetermined ratio; a second purifying unit for again purifying the mixed fluid temporarily stored in the first water storage tank; a second water storage tank for temporarily storing the light water with the high degree of purity or the mixed fluid passing through a second purifying unit; and an output pump provided at an outlet of the second water storage tank to supply the light water or mixed fluid of high purity to the operating fluid supply unit through the supply outlet by pressurizing the light water or the mixed fluid to a pressure ranging from 1 bar to 200 bar.

Herein, the first purifying unit and the second purifying unit can include a micro filter, a reverse osmosis filter, a combination filter and at least one intermediate booster pump, and the output pump is one of: a gear pump, a piston pump or a vane pump to simultaneously apply pressure pulses at a predetermined frequency and average pressure to the operating fluid.

The apparatus for generating energy further includes: a pressure pulse generator provided at the outlet of the operating fluid supply unit for supplying and circulating the operating fluid through the output pump to apply the pulses with a predetermined frequency, wherein the predetermined frequency is a function of the resonance frequencies of the operating fluid, the metallic insert and the dielectric insert.

The dielectric body in accordance with the present invention is provided with a sealing member for high pressure so as not to leak the operating fluid at the flanges of the inlet and outlet. It is made of a material selected from: an industrial plastic, pyrex, a crystal, a ceramic, ruby or silicon carbide.

The metallic insert is selected from: copper, aluminum, gold, silver, palladium or an alloy thereof for easily emitting a plurality of electrons by a thermal exchange due to friction with the operating fluid flowing through the channels of the dielectric body, to facilitate ionization of the operating fluid by the emitted electrons and generate vapor bubbles in large quantities.

The dielectric insert material is selected from: an industrial plastic, pyrex, a crystal, a ceramic, ruby or silicon carbide to retain the electrons in the operating fluid when they are emitted by the nuclear fusion reactions due to cavitation emission.

And also, the dielectric insert is provided with at least one through-hole forming therein an expansion unit of which the inner diameter is constant or is partially expanded at both ends thereof; and the inner surface of the through-hole is a smooth surface or is formed in the shape of a screw to increase friction with the operating fluid and fluidity of the operating fluid.

The metallic member is selected from: copper, iron or a metal with an excellent electrical conductivity to supply a magnetic field capable of separating the ions of the ionized operating fluid or to collect electricity from the ionized operating fluid.

In accordance with another aspect of the present invention, there is provided a method for generating energy, the method including the steps of: supplying an operating fluid; providing an output pump so as to apply to the operating fluid pressure at a predetermined value; providing and circulating the operating fluid supplied from the output pump by means of an operating fluid supply unit; passing the operating fluid from the operating fluid supply unit through a dielectric body which is provided with an inlet, an outlet and a plurality of channels of different diameters connecting the inlet and outlet; ionizing the operating fluid on passing through at least one metallic insert which is provided with at least one through-hole inserted into the channels of the dielectric body; supplying an environment promoting nuclear fusion reactions while the operating fluid passes through the dielectric insert provided with at least one through-hole inserted into the channels of the dielectric body; and being repeatedly circulated in such a way that the electricity of the ionized operating fluid is collected by at least one pair of metallic members inserted into holes intercepting the channels of the dielectric body in a direction vertical to its axis or nuclear fusion is enhanced by separating the ions in the ionized operating fluid using a magnetic field.

### ADVANTAGEOUS EFFECTS

The present invention has the advantage that ionization and nuclear reactions are generated in an operating fluid confined by a dielectric body at normal temperatures without requiring a strong magnetic field to confine a plasma.

Also, the present invention can obtain an energy efficiency from hundreds to thousands of percent of the input energy, either as thermal energy or electrical energy.

The energy generation method includes the steps of: ionization generated in a through-hole of a metallic insert; fine vapor bubble production in the ionized operating fluid due to a pressure difference during flow through a channel of a dielectric body; and further ionization of the operating fluid using a large amount of electron emission and a high voltage generated by cavitation emission produced in the through-hole of the dielectric insert. (This allows the inter-nuclear coulomb barrier between the positive ions to be overcome by electrical impulses due to the high voltage, thereby continuously generating nuclear fusion reactions.)

And also, the present invention is very economical since the construction of the apparatus is simple and the instruments and materials used to construct the apparatus are cheap. As well, the hydrogen isotope (deuterium) consumed is plentiful in sea water.

In addition, the present invention is environment-friendly since the byproducts generated during the energy generating process have a small affect on the environment and emissions (neutron and x-ray flux) are easily shielded by placing a plastic plate of thickness 1 cm around the dielectric body at a distance of 1 m.

### DESCRIPTION OF DRAWINGS

The above and other objects and features of the present invention will become apparent from the following description of the preferred embodiments given in conjunction with the accompanying drawings, in which:

FIG. 1 is a perspective view schematically representing an apparatus for generating energy in accordance with an embodiment of the present invention;

FIG. 2 is a front view schematically illustrating a purifying unit in the apparatus for generating the energy in accordance with one embodiment of the present invention;

FIG. 3 is a perspective view showing a dielectric body in accordance with one embodiment of the present invention;

FIG. 4 is a front view of FIG. 3;

FIG. 5 is a perspective view depicting a metallic insert in accordance with one embodiment of the present invention;

FIG. 6 is a front view of FIG. 5;

FIG. 7 is a perspective view showing a dielectric insert in accordance with one embodiment of the present invention;

FIG. 8 is a front view of FIG. 7;

FIG. 9 is a perspective view representing another example of the dielectric insert in accordance with one embodiment of the present invention;

FIG. 10 is a front view of FIG. 9;

FIG. 11 is a perspective view representing a through-hole in a direction vertical to an axial line, to accept a metallic member on one side of the dielectric body in accordance with one embodiment of the present invention;

FIG. 12 is a side view of FIG. 11; and

FIG. 13 is a front view showing that the metallic member penetrates one side of the dielectric body in accordance with one embodiment of the present invention.

### BEST MODE FOR THE INVENTION

The above-described objects, features and advantages will be clearer by the following detailed description with respect to the accompanying drawings. Hereinafter, preferred embodiments of the present invention will be described in detail with respect to the accompanying drawings.

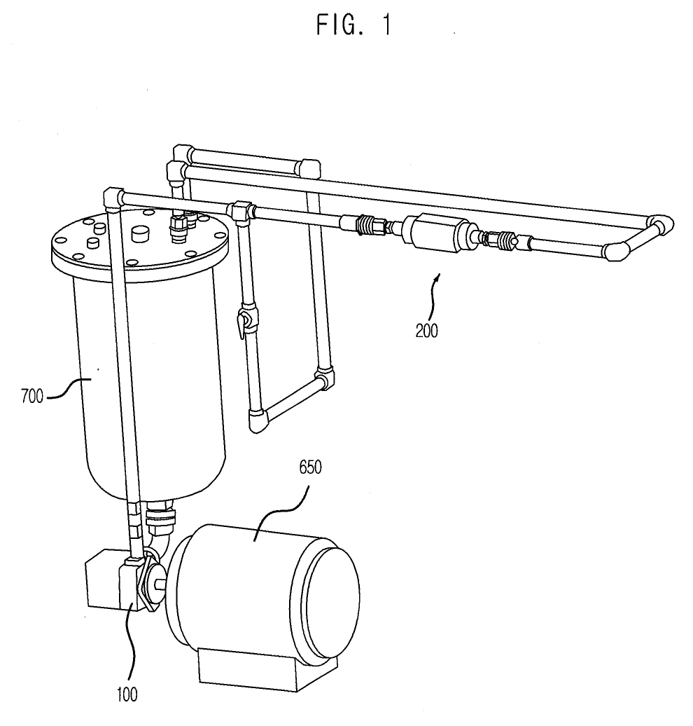

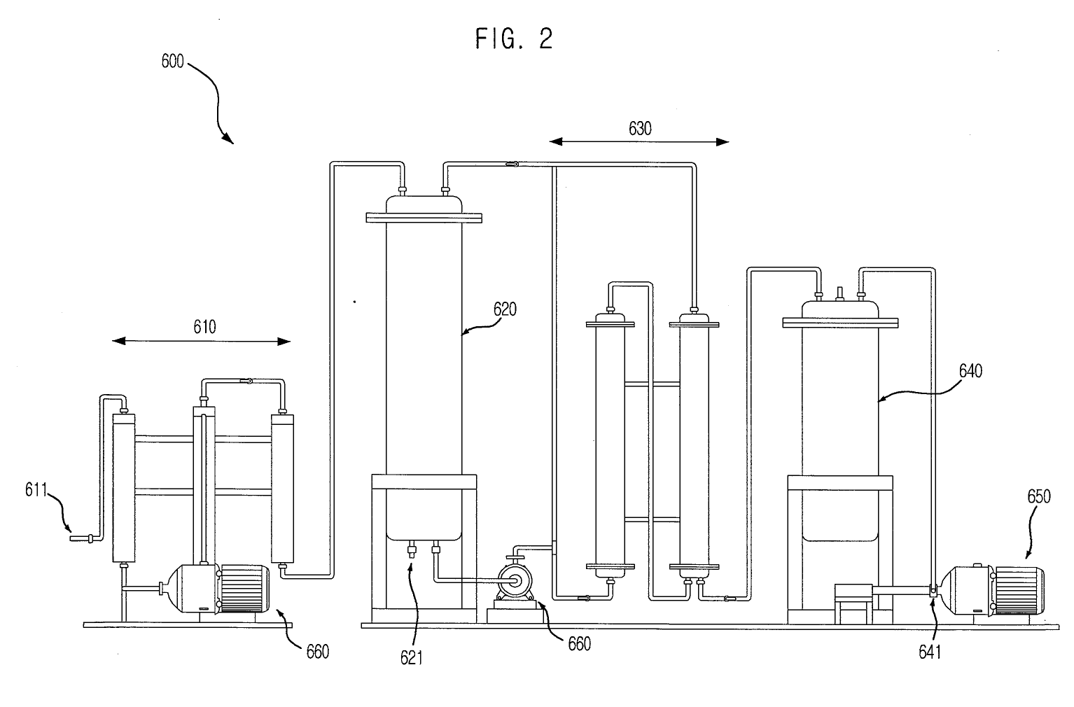

FIG. 1 is a perspective view schematically representing an apparatus for generating energy in accordance with an embodiment of the present invention; and FIG. 2 is a front view schematically illustrating a purifying unit in the apparatus for generating the energy in accordance with one embodiment of the present invention.

An energy generating apparatus and an energy generating method in accordance with the present invention, shown in FIG. 1, are implemented such that a nuclear reaction is generated at a normal temperature without generating a strong magnetic field to confine a high temperature plasma with a high density. An operating fluid is pressurized to a value ranging from 1 bar to 200 bar by means of an output pump 650, and ionization and nuclear fusion processes can be continuously enhanced as the operating fluid passes through a metallic insert 300 in dielectric body 200 and a dielectric insert 400 by applying a pressure pulse with a predetermined frequency to the operating fluid passing through a pipe from an additional pulse generator (not shown) connected to the dielectric body 200 through the operating fluid supply unit 100. Through these processes, the operating fluid is ionized as it is repeatedly and continuously circulated, and nuclear fusion is continuously generated when the ionization is maximized. The pressure, ionization, nuclear fusion and circulation processes are repeated along the paths of the operating fluid supply unit 100 and a heat exchanger 700 in the form of a closed circuit.

The operating fluid in accordance with the present invention is selected from: light water of high purity with resistivity larger than 10⁶ Ω·m; a mixed fluid of high purity with resistivity larger than 10⁶ Ω·m, of which the mixing ratio between light water and heavy water ranges from 100:1 to 100:30; or a mineral oil of viscosity ranging from 5 to 30. The apparatus for generating the energy further includes a purifying unit 600 for purifying the light water and the mixed fluid to a high purity with resistivity larger than 10⁶ Ω·m, to supply purified light water or mixed fluid to the operating fluid supply unit 100 when the operating fluid is to be light water or the mixture.

Herein, the statement that the viscosity of the mineral oil ranges from 5 to 30 means that the industrial viscosity index of the oil ranges from 5 to 30.

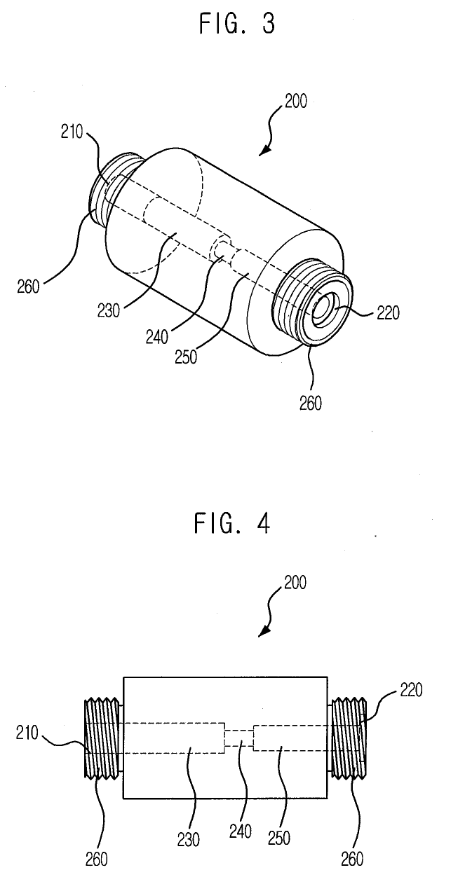

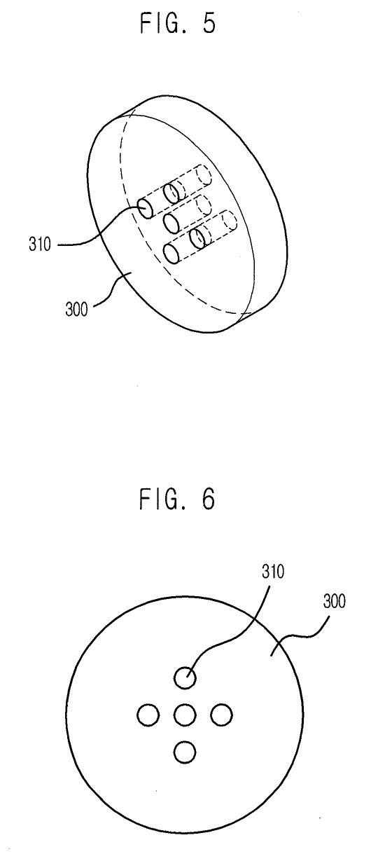

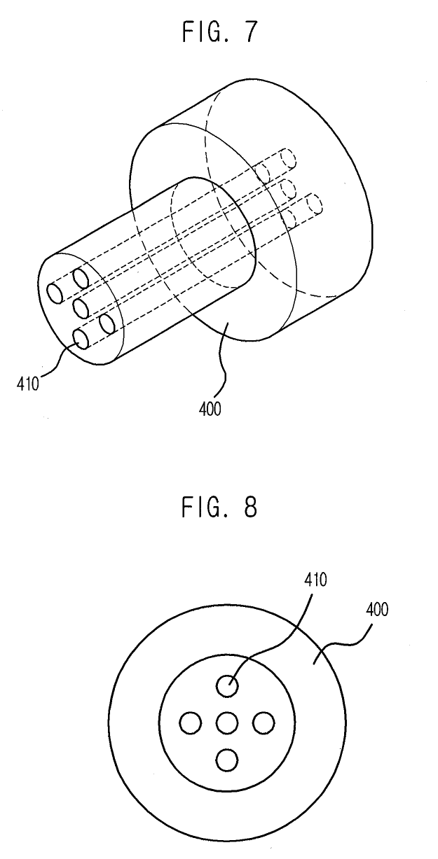

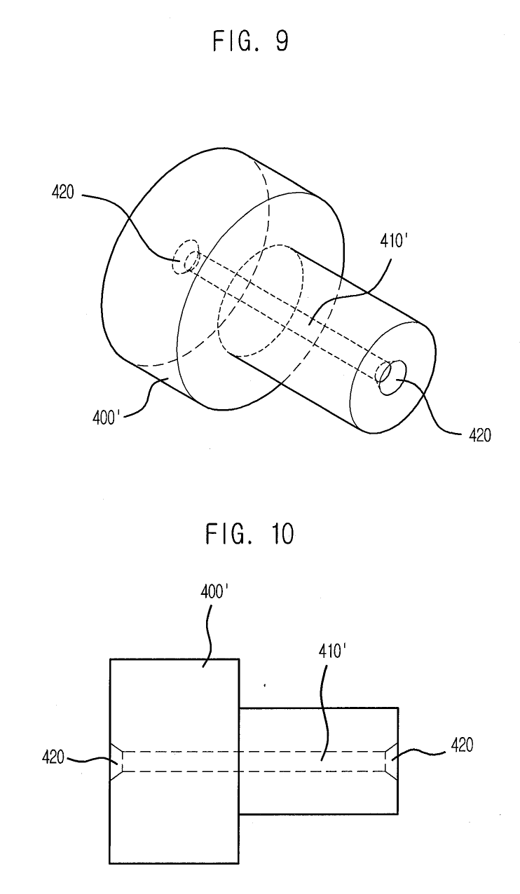

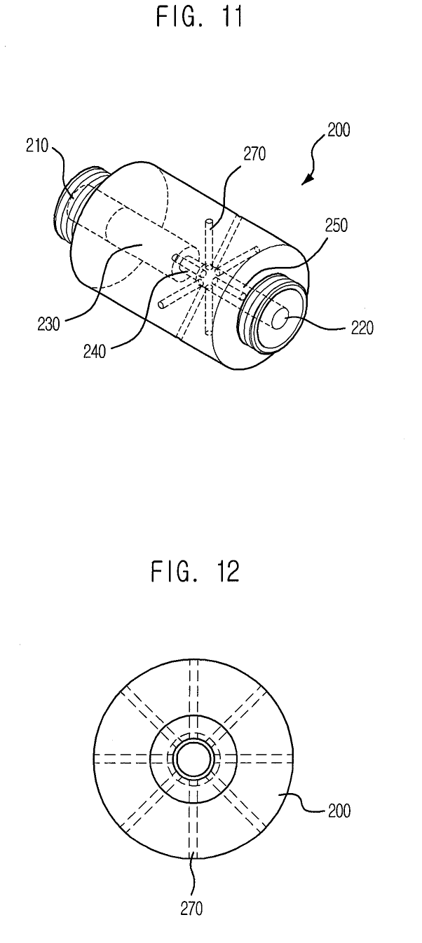

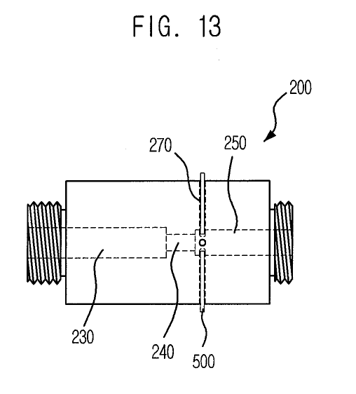

FIG. 3 is a perspective view showing a dielectric body in accordance with one embodiment of the present invention; FIG. 4 is a front view of FIG. 3; FIG. 5 is a perspective view depicting a metallic insert in accordance with one embodiment of the present invention; FIG. 6 is a front view of FIG. 5; FIG. 7 is a perspective view showing a dielectric insert in accordance with one embodiment of the present invention; FIG. 8 is a front view of FIG. 7; FIG. 9 is a perspective view showing another example of the dielectric insert in accordance with one embodiment of the present invention; FIG. 10 is a front view of FIG. 9; FIG. 11 is a perspective view showing that a through-hole penetrates in a direction vertical to an axial line to accept a metallic member on one side of the dielectric body in accordance with one embodiment of the present invention; FIG. 12 is a side view of FIG. 11; and FIG. 13 is a front view showing that the metallic member penetrates one side of the dielectric body in accordance with one embodiment of the present invention.

As shown in FIG. 1 to FIG. 13, the apparatus for generating energy in accordance with the present invention includes: an operating fluid supplied for generating ionization and nuclear fusion reactions; an output pump 650 designed such that the operating fluid is supplied with pressure at a predetermined value; an operating fluid supply unit 100 to supply and circulate the operating fluid through the output pump 650; a dielectric body 200 provided with an inlet 210 and an outlet 220 to conduct the operating fluid supplied from the operating fluid supply unit 100 and a plurality of channels 230, 240 and 250 with different diameters connecting the inlet and outlet; at least one metallic insert 300 provided with at least one through-hole 310 passing the operating fluid by being inserted into the channel 230 of the dielectric body 200 to ionize the operating fluid flowing through the channels 230, 240 and 250; a pair of dielectric inserts 400 and 400′ provided with at least one dielectric through-hole each, 410 and 410′, passing the operating fluid by being inserted into the channel 230 and 240 of the dielectric body 200 to supply an environment promoting nuclear fusion reactions; and at least one pair of metal members 500 to control the polarity of the ionized operating fluid using a magnetic field or to collect electricity by being inserted into a hole 270 which intercepts the channel 250 of the dielectric body 200 in a direction vertical to its axis.

And also, a method for generating energy in accordance with the present invention includes the steps of: supplying an operating fluid; providing an output pump 650 so as to apply to the operating fluid pressure at a predetermined value; supplying and circulating the operating fluid from the output pump 650 by means of an operating fluid supply unit 100; passing the operating fluid from the operating fluid supply unit 100 into a dielectric insert 200 which is provided with an inlet 210, an outlet 220 and a plurality of channels 230, 240 and 250 of different diameters connecting the inlet 210 and outlet 220; ionizing the operating fluid on passing through at least one metallic insert 300 which is provided with at least one through-hole 310 inserted into the dielectric path 230 of the dielectric body 200; supplying an environment promoting nuclear fusion reactions while the operating fluid passes through the dielectric inserts 400 and 400′ provided with at least one through-hole each, 410 and 410′, inserted into the channels 230 and 240 of the dielectric body 200; and being repeatedly circulated in such a way that electricity in the ionized operating fluid is collected by at least one pair of metallic members 500 inserted into opposing holes 270 penetrating the channel 250 of the dielectric body 200 in a direction vertical to an axial line, or nuclear fusion is enhanced by separating the ions in the operating fluid ionized using a magnetic field.

In the energy generating apparatus and method constructed in accordance with the above, light water passed through the purifying unit 600 or a mixed fluid obtained by mixing the light water with heavy water is transmitted to the dielectric body 200, and rapidly passes through the metallic insert 300 installed in the dielectric body 200 via the through-holes 310 and the dielectric through-holes 410 and 410′ of the dielectric inserts 400 and 400′. The ionized operating fluid passes through the through-holes 310 of the metallic insert 300, flows into the channel 230 of the dielectric body 200 (being larger than the through-hole 310 of the metallic insert 300), generates fine vapor bubbles in large quantities due to a rapid drop of the pressure while it passes through the through-holes 410 and 410′ of the dielectric inserts 400 and 400′. Therefore, a very large number of fine vapor bubbles are further generated in the ionized operating fluid when the bubbles reach a state such that the ionization is sufficiently built up by repeated passage through the metallic insert member 300. Meanwhile the operating fluid, including the bubbles, flows into the channels 230, 240 and 250 of the dielectric body 200, being continuously and repeatedly circulated by the output pump 650, then passes through the through-holes 410 and 410′ of the dielectric inserts 400 and 400′.

The fine bubbles implode upon passing through the outlets of the through-holes 410 and 410′, whereupon very high pressure pulses (transiently reaching approximately 10,000 psi pressure) and thermal energy pulses are generated. The pressure waves and the thermal energy released influence the dielectric inserts 400 and 400′ provided with the through-holes 410 and 410′.

Specifically, the temperature of the surfaces of the dielectric inserts 400 and 400′ rises, the amount of electrons emitted by friction with the ionized operating fluid flowing at a rapid speed further increases; and, therefore, the hydrogen separated by cavitation emission at the inner surface of the dielectric inserts 400 and 400′ and the ionized operating fluid carries a positive charge. The emitted electrons generate a so-called Vavilov-Cherenkov radiation effect while diffusing into the operating fluid, as can be verified photographically.

In this way, by emitting electrons carrying the negative charge, the operating fluid contacting a portion of the dielectric through-holes 410 and 410′ becomes negatively charged. The dielectric inserts 400 and 400′ can then be charged with a very high positive voltage without generating discharges, due to their electrical characteristics.

A portion of the operating fluid is ionized by electrical pulses of high voltage generated through these processes, and the positive ions in it are accelerated toward the central axis due to the high voltage formed on the contact portion of the dielectric through-holes 410 and 410′.

As described above, if the transient high voltage of the contact portion of the dielectric through-holes 410 and 410′ formed by cavitation emission reaches the degree of several million volts, and if the operating fluid is a mixture of light water and heavy water, the positive ions of the deuterium (²H) atoms overcome the coulomb barrier by virtue of the electrical pulses and collide by being accelerated to such a degree as to generate nuclear fusion reactions. Such phenomena can be continuously generated by continuously repeating the process of reacting the hydrogen generated through ionization of the operating fluid and fine cavitation emission, and the deuterium generated in the fusion of hydrogen with hydrogen through the circulation of the operating fluid.

At this time, the formulas for representative nuclear fusion reactions are as follows:

¹H+¹H→²H+e⁺+neutrino+0.93 MeV [reaction formula 1]

²H+¹H→³He+γ+5.49 MeV

²H+²H→³He+n+3.26 MeV

²H+³He→⁴He+P+18.3 MeV [reaction formulas 2]

The energy released by the nuclear fusion reactions is accompanied by the emission of neutrons and γ-radiation; these can be verified by experiment. And also, since the reaction energy ionizes the hydrogen or the deuterium atoms included in the operating fluid or the deuterium atoms generated through the reaction of formula 1, such nuclear fusion reactions can be continuously generated.

Hereinafter, an apparatus and a method for generating energy which are based on the above are described in more detail as follows.

The operating fluid in accordance with the present invention is selected from: light water of high purity with resistivity larger than 10⁶Ω·m; a mixed fluid of high purity with resistivity larger than 10⁶Ω·m, of which the mixing ratio between light water and heavy water ranges from 100:1 to 100:30; or a mineral oil of viscosity ranging from 5 to 30. The apparatus for generating the energy further includes a purifying unit 600 for purifying the light water and the mixed fluid to a high purity with resistivity larger than 10⁶ Ω·m when the operating fluid is light water or the mixed fluid.

As shown in FIG. 2, the purifying unit 600 includes: a first purifying unit 610 for receiving the light water from an outside source through a light water inlet 611 to initially purify the received light water; a first water storage tank 620 for storing only the light water passing through the first purifying unit 610 or for mixing pure heavy water supplied through a heavy water inlet 621 with the light water passing through the first purifying unit 610 in a predetermined ratio (that is, it performs the storage of water when only the light water is used); a second purifying unit 630 for again purifying the mixed fluid temporarily stored in the first water storage tank 620; a second water storage tank 640 for temporarily storing the light water or the mixed fluid of high purity passing through the second purifying unit 630; and an output pump 650 provided at an outlet of the second water storage tank to supply the light water or the mixed fluid to inlet 210 of the dielectric body 200 through the supply outlet 641, applying to the light water or the mixed fluid a pressure ranging from 1 bar to 200 bar.

Herein, when the operating fluid is a mineral oil, since the purifying unit 600 is not required, the output pump 650 is directly connected to the operating fluid supply unit 100. A preferred pressure of the output pump 650 is 80 bars for the light water or the mixed fluid and is 50 bars for the other operating fluids.

It is preferable that the light water stored at the second water storage tank 640 and passed through the first and the second purifying units 620 and 640 or the mixed fluid of light water and heavy water has a specific resistance being larger than a minimum of 10⁶ Ω·m. The first and the second purifying units 620 and 640 are constructed to include a micro filter, a reverse osmosis filter or a combination filter, and further include at least one intermediate booster pump 660 (a conventional extrapure water pump). The intermediate booster pump 660 can be one of a variety of pumps such as a rotary pump, a reciprocating pump or a centrifugal pump, and it is preferable that the output pump 650 be a pump such as a gear pump, a piston pump, a vane pump or the like so as to apply a constant pressure pulse frequency and average pressure to the operating fluid at the same time.

The energy generation apparatus and the energy generation method using the light water of high purity, a mixed fluid of pure light water and heavy water, or mineral oil, further includes a pulse generator (not shown) mounted where the operating fluid, pressurized by the output pump 650, is supplied to the inlet 210 of the dielectric body 200. The pulse generator can apply a pulse with a predetermined frequency to the operating fluid; the frequency is a function of the resonance frequencies of the operating fluid, the metallic insert 300 and the dielectric inserts 400 and 400′.

As shown in FIG. 3 and FIG. 4, the dielectric body 200 is made of various shapes such as a hollow circular or rectangular rod, and a sealing member for high pressure is provided at the inlet 210 of the dielectric body 200 and the flange 260 of the dielectric outlet 220 so as not to leak the operating fluid at high pressures.

Herein, the dielectric body 200 is resistant to the heat generated by the cavitation emission and is formed from a dielectric material to maintain the ionization of the operating fluid to enhance the cavitation emission. For example, it is preferable that one of: an industrial plastic, pyrex, quartz, a ceramic, sapphire or ruby be used as the material of the dielectric body 200 among materials having a high dielectric constant. A material such as silicon carbide (SiC) or a silicon carbide sintered body can be used, but it is not limited to these; another suitable material can be used if it has a high dielectric constant.

And also, at least one of channels 230, 240 and 250 having different diameters from each other are formed inside of the dielectric body 200 and the operating fluid is conducted therein. It can be taken as a standard that: the length of the dielectric body 200 ranges from 50.0 mm to 500 mm; the diameter of the channel 230 ranges from 5 mm to 490 mm; the diameter of the channel 240 ranges from 3 mm to 488 mm; diameter of the channel 250 ranges from 4 mm to 489 mm. However, according to experiments in accordance with the embodiment of the present invention, it is preferable that: the length of the dielectric body 200 be 180 mm; the diameter of the channel 230 be 22 mm; the diameter of the channel 240 be 12 mm; and the diameter of the channel 250 be 16 mm.

As shown in FIG. 5 and FIG. 6, the metallic insert 300 will emit electrons through thermal exchange due to friction with the operating fluid flowing through the channel 230 of the dielectric body 200. This facilitates the ionization of the operating fluid by the emitted electrons, and generates a large quantity of bubbles in the channel 230. The material of the metallic insert 300 is selected from: copper, solid aluminum or aluminum foil, gold, silver, platinum, palladium or an alloy thereof, to readily emit a plurality of electrons by thermal energy exchange, but it is not limited to these; other suitable materials can be used if they can easily emit electrons.

And also, in order to maximize the emission of electrons, one or a number of metallic inserts 300 may be sequentially inserted into the channel 230 inside of the dielectric body 200, with small spacing intervals. It can be taken as standard that; the thickness of the metallic insert 300 ranges from 0.01 mm to 10 mm; and the diameter of the through-hole 310 ranges from 1 mm to 10 mm. However, according to experiment in accordance with the embodiments of the present invention, it is preferable that the thickness of the metallic insert 300 be 4 mm and the diameter of the through-hole 310 be 2 mm.

As shown in FIG. 7 and FIG. 8, in order that the dielectric insertion member 400 provide an environment conducive to nuclear fusion reactions due to cavitation emission, the material of the dielectric insert 400 is to be the same as that of the dielectric body 200 or, when a very large number of electrons are emitted by the fusion reactions, a material such as asbestos or a synthetic polymer containing fluorine is advantageous in maintaining the emitted electrons in the operating fluid. In the dielectric insert 400, at least one through-hole 410 is formed. It can be taken as standard that: the through-hole 410 is in the shape of a cylinder; the length of the through-hole 410 ranges from 10 mm to 100 mm; and the diameter of the through-hole 410 ranges from 1 mm to 30 mm. According to experiments in accordance with the embodiments of the present invention, it is preferable that the length of the dielectric insert 400 be 29 mm and the diameter of the dielectric insert 400 be 2 mm.

And also, although the dielectric insert 400 can be made of: an industrial plastic, pyrex, a crystal, a ceramic, ruby, silicon carbide or a silicon carbide sintered body to maintain the electrons in the operating fluid, it is not limited to these; another suitable material can be used if it has a high dielectric constant.

FIG. 9 and FIG. 10, show another example of the dielectric insert 400′. As shown in the drawings, the dielectric insert 400′ is provided with at least one throughhole 410′ forming an expansion unit 420 with a constant inner diameter or a partially enlarged inner diameter at both ends, and the inner surface of the through-hole 410′ is smooth or is in the shape of a screw in order to increase the friction with the operating fluid and the fluidity of the operating fluid.

In other words, although the through-hole 410 shown in FIG. 7 and FIG. 8 has a constant diameter, the through-hole 410′ shown in FIG. 9 and FIG. 10 is provided with the expansion unit 420 to increase the friction surface and the speed of flow of the operating fluid. That is, the diameters of the inlet and the outlet can be enlarged to between 0.5 mm and 1 mm, with a preferable diameter of 0.754 mm. And also, in the dielectric through-hole 410′, the friction and the generation of bubbles can be maximized by additionally providing the screw shape.

As shown in FIG. 11 to FIG. 13, in order to supply a magnetic field for separating the ions of the ionized operating fluid or to collect electricity from the ionized operating fluid, the metallic member 500 can be a metal rod selected from: copper, iron or a metal having an excellent electric conductivity. In other words, by means of at least one pair of holes 270 penetrating along a direction vertical to an axial line of the channel 250 from the outside of the dielectric body 200, electricity is collected from the ionized operating fluid flowing in the channel 250 by passing the metal rod 500 through each hole 270 to the inside of the channel 250, or the nuclear fusion of hydrogen can be promoted in the repeated circulation by separating the ions such as the hydrogen ions in the ionized operating fluid flowing along the channel 250.

Hereinafter, the metallic member 500 is constructed and operated as specifically described. Ionization of the operating fluid denotes that the operating fluid partially exists in the plasma state while circulating through the system. Therefore, in collecting the electron flow from the ionized operating fluid (that is, from the plasma), the flow of the electrons can be generated as electricity by magnetohydrodynamical means. That is, the electron (electric) current in the dielectric body 200 is confined to the operating fluid and, by penetrating the metal rod 500 to the inside of the dielectric path 250, the electrons are concentrated into the metallic rod 500, and electricity can be generated by discriminating the polarities according to the magnetic field adopted at this time to produce a direct current or an alternating current in response to the polarity. The electron (electric) current is confined in the dielectric body 200 because it is constructed of a dielectric material.

In like manner, all pipe portions (that is, paths 230, 240 and 250, the through-hole 310, the through-holes 410 and 410′ or the like), in which the operating fluid is circulated, can be coated with an excellent plastic material (that is, Kevlar, a fiber glass or the like) or a pipe made of the above-described materials can be used, to impart the desired dielectric properties to the inside surface of the pipe.

Herein, the holes 270 of the dielectric body 200, for insertion of the metallic rods 500, form an opposed pair, and they have a direction vertical to the body axis. Therefore, in the outside of the dielectric body 200, the number of the holes 270 is an even number, and each of the opposed holes face each other with respect to the axial line. The external ends of the metallic members, that is the metal rods 500, contact the ionized operating fluid flowing in the channel 250 by penetrating into the channel 250, and are connected to a device to accumulate the collected electricity or are connected to a permanent magnet or an electromagnet to separate the ions of the ionized operating fluid. And also, the process of accumulating the electricity is achieved by connecting a wire to the end portions of the metal rods 500 and performing conventional rectifying and accumulating processes. In this way, electrical energy can be generated from the plasma while consuming much less energy in the system.

Hereinafter, the operations and effects of the energy generating apparatus and method following the above-described procedures are described in detail as follows.

First, the operating fluid in accordance with the embodiment of the present invention is selected from: light water of high purity with resistivity larger than 10⁶ Ω·m; a mixed fluid of high purity with resistivity larger than 10⁶ Ω·m, of which the mixing ratio between light water and heavy water ranges from 100:1 to 100:30; or a mineral oil of viscosity ranging from 5 to 30. When using a mixed fluid of light water and heavy water as the operating fluid, the light water and the heavy water are mixed in the purifying unit 600 at a mixing ratio ranging from 100:1 to 100:30. From the results of experiments of the energy generating apparatus in accordance with the present invention, it is found preferable that the mixing ratio be 100:3 for nuclear fusion reactions capable of obtaining the maximum generation efficiency (approximately 2,000% of the input energy). After mixing, the mixed fluid is purified to a state such that the specific resistance is a minimum 10⁶ Ω·m; and, even if only light water is used, it is purified to a state such that the specific resistance is a minimum 10⁶ Ω·m. And also, the fluid is pressurized to a pressure ranging from 1 bar to 200 bars using the output pump 650. The ionization and nuclear fusion processes can further be continuously enhanced as the operating fluid passes through the metallic insert 300 in the dielectric body 200 and the dielectric inserts 400 and 400′, by applying a pressure pulse (having a predetermined frequency) to the operating fluid passing through the pipe, by means of a pulse generator additionally installed on the pipe connected to the inlet 210 of dielectric body 200.

Herein, it is preferable that the frequency (pulse) of the pressure wave be matched to the resonance frequency of the system, which depends on the material of the dielectric body 200, the lengths and diameters of the through-holes 410 and 410′ formed in the dielectric inserts 400 and 400′ and the physical properties of the operating fluid. It can be experimentally determined by gradually changing the frequency of the pulse generator. Although an approximate frequency range is from 1 KHz to 100 MHz, a preferable range of the frequency in accordance with the experiment is 1.0 MHz for the case that the light water is included, and is 20 MHz for the other operating fluids. However, since the frequency range also changes during the passage of operating time, and depends on the temperature, the amount of charge, the dielectric material used, the type of metallic insert and the like, the frequency has to be changed during the operation of the energy generating apparatus.

The operating fluid is accelerated on passing through the narrow through-holes 410 and 410′ of the dielectric inserts 400 and 400′, and a large number of vapor bubbles are generated by boiling the operating fluid at a relatively low temperature since the pressure is rapidly dropped upon passing through these channels. At this time, the generated fine vapor bubbles are expanded and circulated an initial time and again flow into the channel 230 of the dielectric body 200; the flowing operating fluid undergoes ionization on passing again through the narrow through-hole 310 of the metallic insert 300. After passing through the through-hole 310, the flowing operating fluid undergoes another bubble generation process in the channel 230. Thereafter, a pressure wave with a high pressure is locally generated by the implosion of a huge number of ultra fine bubbles in the ionized operating fluid after passing through the dielectric inserts 400 and 400′, and cavitation emission occurs. The thermal energy generated in the ionized operating fluid is released on passing through the heat exchanger 700 of the operating fluid supply unit, and the ionized operating fluid is recirculated by the output pump 650.

The cavitation emission can be enhanced if the wave at the resonance frequency from the pulse generator is applied to the flowing operating fluid to which was previously applied the wave from the output pump 650. Through these processes, the portion of the through-holes 410 and 410′ contacting the operating fluid develops a high voltage (approximately 1 MV). These effects are the result of the dielectric properties of the dielectric inserts 400 and 400′ as described above.

The operating fluid undergoes the nuclear fusion reaction of formula 1 at the initial time of operation (for all operating fluids). Deuterium is generated by this means (deuterium is also initially present in concentrations greater than normal when the operating fluid includes heavy water). The hydrogen and deuterium atoms are again ionized by losing electrons due to the high voltage. The positive ions of deuterium among these overcome the coulomb barrier by virtue of the electrical impulses, and the nuclear fusion reactions of reaction formula 2 can occur.

As byproducts of the nuclear fusion reactions, neutrons and y-rays are emitted and thermal and electrical energy are released. In accordance with the embodiment of the present invention, if the input energy is approximately 7.5 KW, thermal energy corresponding to approximately 37.5 KW can be obtained on average, this is an energy efficiency of approximately 500%. And also an energy efficiency corresponding to on average 2,000% can be obtained by increasing the mixing ratio of the heavy water. As for electrical energy, if an amount of the input power is approximately 7.5 KW, electricity of approximately 45 KW (30A, 1500V) is generated on average. At this time, the output of neutrons is on average 3.3 mrem/hour, measured at the surface of the dielectric body 200 having the preferred dimensions (that is, the length of the dielectric body 200 is 180 mm, the diameter of the channel 230 is 22 mm, the diameter of channel 240 is 12 mm, the diameter of channel 250 is 16 mm). The energy generating apparatus and method in accordance with the present invention can yield much greater thermal and electrical energy by operating a plurality of dielectric bodies 200 together at the same time.

While the present invention has been described with respect to certain preferred embodiments, it will be apparent to those skilled in the art that various changes and modifications may be made without departing from the scope of the invention as defined in the following claims.

What is claimed:

1. An apparatus for generating energy, the apparatus comprising:
an operating fluid supplied for generating an ionization reaction and a nuclear fusion reaction;
an output pump designed such that the pressure of the operating fluid can be applied at a predetermined value;
an operating fluid supply unit to supply and circulate the operating fluid through the output pump;
a dielectric body provided with an inlet and outlet to conduct the operating fluid supplied from the operating fluid supply unit and a plurality of channels with different diameters connecting the inlet and outlet;
at least one metallic insert provided with at least one through-hole passing the operating fluid by being inserted into the channels of the dielectric body, to ionize the operating fluid;
a dielectric insert provided with at least one through-hole passing the operating fluid by being inserted into the channels of the dielectric body, to supply an environment promoting nuclear fusion reactions; and
at least one pair of metal members to control the polarity of the ionized operating fluid or to collect electricity by being inserted into holes which intercept the channels of the dielectric body in a direction vertical to its axis.

2. An apparatus as recited in claim 1, wherein the operating fluid is one of: light water of high purity with resistivity larger than 10⁶ Ω·m, a mixed fluid of high purity with resistivity larger than 10⁶ Ω·m, of which the mixing ratio between light water and heavy water ranges from 100:1 to 100:30; or a mineral oil of viscosity ranging from 5 to 30.

3. An apparatus as recited in claim 2, further includes:
a purifying unit for purifying the light water and the mixed fluid to high purity with resistivity larger than 10⁶ Ω·m to supply the purified light water and the mixed fluid to the operating fluid supply unit when the operating fluid is light water or the mixture of light water and heavy water.

4. The apparatus as recited in claim 3, wherein the purifying unit includes:
a first purifying unit for receiving the light water from an outside source through a light water inlet to initially purify the received light water;
a first water storage tank for storing only the light water passing through the first purifying unit or for mixing pure heavy water supplied through a heavy water inlet with the light water passing through the first purifying unit in a predetermined ratio;
a second purifying unit for again purifying the mixed fluid temporarily stored in the first water storage tank;
a second water storage tank for temporarily storing the light water of high purity or the mixed fluid passing through the second purifying unit; and
an output pump provided at an outlet of the second water storage tank to supply the light water of high purity or the mixed fluid to the operating fluid supply unit through the supply outlet by applying pressure in the range from 1 bar to 200 bar to the light water or the mixed fluid.

5. The apparatus as recited in claim 4, wherein the first purifying unit and the second purifying unit include a micro filter, a reverse osmosis filter, a combination filter and at least one intermediate booster pump.

6. The apparatus as recited in claim 1, wherein the output pump is one of: a gear pump, a piston pump or a vane pump, to simultaneously apply a predetermined frequency of pressure pulses and an average pressure to the operating fluid.

7. The apparatus as recited in claim 6 further includes:
a pulse generator provided at an outlet of the operating fluid supply to apply a predetermined frequency of pressure pulses to the operating fluid.

8. The apparatus as recited in claim 7, wherein the predetermined frequency is a function of the resonance frequencies of the operating fluid, the metallic insert and the dielectric insert.

9. The apparatus as recited in claim 1, wherein the dielectric body is provided with a sealing member for high pressure so as not to leak the operating fluid from the flanges of the dielectric inlet and the dielectric outlet, and it is made of a material selected from: an industrial plastic, pyrex, a crystal, a ceramic, ruby or silicon carbide, wherein the dielectric inlet and the dielectric outlet are connected by flanges.

10. The apparatus as recited in claim 1, wherein the metallic insert is selected from: copper, aluminum, gold, silver, palladium or an alloy thereof for easily emitting a plurality of electrons by thermal energy exchange due to friction with the operating fluid flowing through the channels of the dielectric body, to facilitate ionization of the operating fluid by the emitted electrons and generate vapor bubbles in large quantities.

11. The apparatus as recited in claim 1, wherein the dielectric insert is made of a material selected from: an industrial plastic, pyrex, a crystal, a ceramic, ruby or silicon carbide to maintain the electrons in the operating fluid when the electrons are emitted by the nuclear fusion reactions due to cavitation emission.

12. The apparatus as recited in claim 11, wherein the dielectric insert is provided with at least one through-hole forming therein an expansion unit of which the inner diameter is constant or is partially expanded at both ends thereof; and the inner surface of the through-hole is a smooth surface or is formed in the shape of a screw to increase the friction with the operating fluid and the fluidity of the operating fluid.

13. The apparatus as recited in claim 1, wherein the metallic member is selected from: copper, iron or a metal with an excellent electrical conductivity, to supply a magnetic field capable of separating the ions of the ionized operating fluid or to collect electricity from the ionized operating fluid.

14. A method for generating energy, the method comprising the steps of:
supplying an operating fluid;
providing an output pump so as to apply pressure to the operating fluid at a predetermined value;
supplying and circulating the operating fluid from the output pump through an operating fluid supply unit;
passing the operating fluid from the operating fluid supply unit through a dielectric body which is provided with an inlet, an outlet and a plurality of channels of different diameters connecting the inlet and the outlet;
ionizing the operating fluid by passing it through at least one metallic insert which is provided with at least one metallic through-hole inserted into the channels of the dielectric body;
supplying an environment promoting nuclear fusion reactions while the operating fluid passes through the dielectric insert provided with at least one dielectric through-hole inserted into the channels of the dielectric body; and
being repeatedly circulated while that electricity in the operating fluid is collected by at least one pair of metallic members inserted into holes penetrating the channels of the dielectric body in a direction vertical to its axis or nuclear fusion is promoted by separating the ions in the ionized operating fluid using a magnetic field.

15. A method as recited in claim 14, wherein the operating fluid selected from: light water of high purity with resistivity larger than 10⁶ Ω·m; a mixed fluid of high purity with resistivity larger than 10⁶ Ω·m, of which the mixing ratio between light water and heavy water ranges from 100:1 to 100:30; or a mineral oil of viscosity ranging from 5 to 30, and further includes:
a purifying unit for purifying the light water and the mixed fluid to a high purity with resistivity larger than 10⁶ Ω·m to supply purified light water or mixed fluid to the operating fluid supply unit when light water or the mixed fluid are to be used.

16. The method as recited in claim 15, wherein the purifying unit includes:
a first purifying unit for receiving the light water from an outside source through a light water inlet to initially purify the received light water;
a first water storage tank for storing only the light water passing through the first purifying unit or for mixing pure heavy water supplied through a heavy water inlet with the light water passing through the first purifying unit in a predetermined ratio;
a second purifying unit for again purifying the mixed fluid temporarily stored in the first water storage tank;
a second water storage tank for temporarily storing the light water with the high degree of purity or the mixed fluid passing through the second purifying unit; and
an output pump provided at an outlet of the second water storage tank to supply the light water of high purity or the mixed fluid to the supply unit through the supply outlet by applying to the light water or the mixed fluid a pressure ranging from 1 bar to 200 bar,
wherein the first purifying unit and the second rectifying unit include a micro filter, a reverse osmosis filter, a combination filter and at least one intermediate booster pump, and
wherein the output pump is selected from: a gear pump, a piston pump or a vane pump to simultaneously apply a predetermined frequency of pressure pulses and an average pressure to the operating fluid.

17. The method as recited in claim 16, further includes:
a pulse generator provided at an outlet of the operating fluid supply to apply pressure pulses with a predetermined frequency, wherein the predetermined frequency is a function of the resonance frequencies of the operating fluid, the metallic insert and the dielectric insert.

18. The method as recited in claim 14, wherein the dielectric body is provided with a sealing member for high pressure so as not to leak the operating fluid from the flanges of the inlet and the outlet, and is made of a material selected from: an industrial plastic, pyrex, a crystal, a ceramic, ruby or silicon carbide, wherein the inlet and the outlet are connected by flanges.

19. The method as recited in claim 14, wherein the metallic insert is selected from: copper, aluminum, gold, silver, palladium or an alloy thereof for easily emitting a plurality of electrons by a thermal energy exchange due to friction with the operating fluid flowing through the channels of the dielectric body, to facilitate ionization of the operating fluid by the emitted electrons and generate vapor bubbles in large quantities.

20. The method as recited in claim 14, wherein the dielectric insert is selected from: an industrial plastic, pyrex, a crystal, a ceramic, ruby or silicon carbide to maintain the electrons in the operating fluid when the electrons are emitted by the nuclear fusion reactions due to cavitation emission,
the dielectric insert is provided with at least one through-hole forming therein an expansion unit of which the inner diameter is constant or is partially expanded at both ends thereof; and
an inner surface of the through-hole is a smooth surface or is formed in the shape of a screw to increase the friction with the operating fluid and the fluidity of the operating fluid.

21. The method as recited in claim 14, wherein the metallic member is selected from: copper, iron or a metal with an excellent electrical conductivity to supply a magnetic field capable of separating the ions of the ionized operating fluid or to collect electricity from the ionized operating fluid.
